(19) United States
(12) Patent Application Publication
(10) Pub. No.: US 2008/0179244 A1
(43) Pub. Date: Jul. 31, 2008

(54) DRAIN-FLUSH SEQUENCE AND SYSTEM FOR FILTER MODULE

(75) Inventors: Charles R. Morgan, Fort Lauderdale, FL (US); Louis E. Lebrun, Fort Lauderdale, FL (US); Andrew Ball, Deerfield Beach, FL (US)

Correspondence Address: FOLEY AND LARDNER LLP;SUITE 500, 3000 K STREET NW, WASHINGTON, DC, 20007, US

(73) Assignee: Parkson Corporation

(21) Appl. No.: 11/627,870

(22) Filed: Jan. 26, 2007

(51) Int. Cl. B01D 24/46; B01D 65/02; C02F 1/44

(52) U.S. Cl. 210/636; 210/108

(57) ABSTRACT

The disclosed system and apparatus can be used to improve the operation of a membrane bioreactor wastewater treatment system. The system may include one or more membrane filtration modules having a proximal end and a distal end in which each module houses one or more membrane filters. The system and method can be configured to include the steps of interrupting the introduction or flow of feed liquid, allowing at least a portion of the feed liquid present in the one or more membrane filtration modules to drain therefrom, and to resume the introduction or feed of the feed liquid. Optionally, the system and method can include the step of allowing at least a portion of the recovered permeate to backflush the one or more membrane filters.

### BACKGROUND

Membrane bioreactors are known in the art as a treatment process for wastewater. These bioreactors combine an activated sludge biological process with membrane filtration. The filter membrane modules typically comprise hollow membranes within a casing in which the feed liquid flows through the membranes in a longitudinal direction and cleaned water, or permeate, flows toward the space between the casing and the membranes, where it is discharged via a permeate discharge system. An example of one such filter membrane module is disclosed in U.S. Pat. No. 5,494,577.

During operation of these systems, solids are retained at the membrane wall of the filters within each individual membrane tube. Under certain process conditions, these solids accumulate and form a layer that becomes progressively thicker over time and reduce the annular space inside the tube. This process can rapidly accelerate as solids are dewatered by the membrane, accumulate in the tube, and reduce the flow. If left unaddressed, these solids form “plugs” inside the membrane tube(s) effectively blocking the flow and removing the membrane tube from service. This reaction, in turn, increases the loading of solids to the other membrane tubes; thus, spreading and accelerating the process through the system. Effectively preventing and/or reversing the accumulation of solids and plug formation are desirable for the effective performance of the wastewater treatment system.

To help prevent the accumulation of solids and plug formations, it is conventional to perform a backwashing process in which the flow of the feed liquid through the membrane filtration module is reversed such that the permeate flows through the membrane in the reverse direction of normal filtration flow in the hopes of dislodging the solids and plugs that has collected in the filter membranes. However, this type of cleaning process has limited success.

However, if backwashing were performed on an empty tube, a tremendous amount of turbulent flow can result within each membrane tube via a two-phase flow. This turbulence tends to dislodge solids at the membrane wall. In addition, a column of liquid may form around the accumulated solids to provide the forces necessary to dislodge and remove them. Thus, if a draining process were performed to empty the membrane tube, and then a backwashing process is performed, the net change in pressure across the membrane can be maximized; thereby increasing the effectiveness of the backwashing process.

### SUMMARY

According to an embodiment of the present invention, a method of operating a membrane bioreactor wastewater treatment system is disclosed in which the system can comprise a bioreactor and one or more membrane filtration modules. Each module can have a proximal end and a distal end and may house a plurality of membrane filters. Influent can be introduced into the bioreactor and from which bioreactor a feed liquid is obtained which is introduced, in turn, to the proximal end of the one or more membrane filtration modules. A substantial portion of the feed liquid can be recovered from the distal end of the one or more membrane filtration modules and may be returned to the bioreactor. However, at least a portion of the feed liquid can be allowed to pass from one side of the plurality of membrane filters and out an opposite side thereof to provide a permeate. The method may comprise the steps of: interrupting the introduction of the feed liquid to the proximal end of the one or more membrane filtration modules; allowing at least a portion of the feed liquid present in the one or more membrane filtration modules to drain therefrom, along with at least a portion of any residue that might have accumulated on the one side of said plurality of membrane filters; and resuming the introduction of the feed liquid to the proximal end of the one or more membrane filtration modules.

The method can include one or more of the following aspects: the introduction of the feed liquid is interrupted by closing an input valve; the at least a portion of said feed liquid is allowed to drain by the action of gravity; the at least a portion of the feed liquid is allowed to drain by opening a drain valve; prior to the resumption of the introduction of the feed liquid, the plurality of membrane filters can be flushed by causing at least a portion of the permeate to flow from the opposite side of said plurality of membrane filters and out the one side thereof or to flow from the one side of said plurality of membrane filters and out the opposite side of thereof; a first chemical solution is introduced into the one or more membrane filtration modules; a second chemical solution is introduced into the one or more membrane filtration modules; the first chemical solution and/or the second chemical solution can comprise one or more hypochlorite, acid, caustic, surfactant, or any combination thereof; and the introduction of said feed liquid can be interrupted at least once for every six hours of continuous operation of the said membrane bioreactor wastewater treatment system.

According to another embodiment of the present invention, a method of maintaining a membrane filtration module is disclosed in which the membrane filtration module can have a proximal end and a distal end and can house one or more tubular membrane filters through which a substantial portion of a feed liquid is allowed to flow into the proximal end and out the distal end of the membrane filtration module. At least a portion of the feed liquid can be allowed to pass from one side of the one or more membrane filters and out an opposite side thereof to provide a permeate. The method may comprise: interrupting the flow of feed liquid; allowing at least a portion of said feed liquid present in the membrane filtration module to drain therefrom, along with at least a portion of any residue that might have accumulated on one side of the one or more tubular membrane filters; flushing the one or more tubular membrane filters by allowing an effective amount of permeate to flow from said opposite side of the one or more tubular membrane filters and out the one side thereof or to flow from said one side of the one or more tubular membrane filters and out said other opposite side thereof; and resuming the flow of feed liquid.

The method can include one or more of the following aspects: an effective amount of permeate can range from about 0.05× to about 10× the total volume of the membrane filtration module; the flushing step can be carried out during or after the at least a portion of said feed liquid is allowed to drain; and the at least a portion of said feed liquid can be allowed to drain by opening a drain valve positioned below the one or more tubular membrane filters and opening a vent positioned above same.

According to another embodiment of the present invention, a membrane wastewater filtration system is disclosed, which may comprise one or more membrane filtration modules having a proximal end and a distal end in which each module houses one or more tubular membrane filters; at least one inlet for introducing feed liquid; at least one drain positioned below the one or more tubular membrane filters; at least a first outlet for recycling a substantial portion of feed liquid introduced; at least a second outlet for recovering permeate; and at least one controller. The at least one controller can be configured to (i) interrupt the introduction of feed liquid, (ii) allow at least a portion of feed liquid present in the one or more membrane filtration modules to drain therefrom, and (iii) allow at least a portion of recovered permeate to backflush the one or more tubular membrane filters.

The system can include one or more of the following aspects: a first pump for feeding the feed liquid to the at least one inlet and a circulation valve in fluid communication with the first pump and the controller is configured to close the circulation valve to interrupt the introduction of the feed flow; a second pump in fluid communication with the second outlet and a draining valve in fluid communication with the at least one drain; the controller can be configured to turn on the second pump while the draining valve is open; the controller may be configured to close the draining valve before turning on the second pump; an air blower for introducing air in the vicinity of the proximal end of the one or more membrane filtration modules and the controller is configured to control the air blower to run while the draining valve is open, the second pump is in operation, or any combination thereof; a chemical solution source and chemical flow valve in fluid communication with the second pump and the controller is configured to open the chemical flow valve and to operate the second pump; and an air blower for introducing air in the vicinity of the proximal end of the one or more membrane filtration modules.

It is to be understood that both the foregoing general description and the following detailed description are exemplary and explanatory only, and are not restrictive of the invention as claimed.

### BRIEF DESCRIPTION OF THE DRAWINGS

The features, aspects and advantages of the present invention will become apparent from the following description, appended claims, and the accompanying exemplary embodiments shown in the drawings, which are briefly described below.

FIG. 1 is a schematic diagram of a wastewater system according to an embodiment of the present invention.

FIG. 2 is a schematic diagram of the membrane filtration module according to an embodiment of the present invention.

FIG. 3 is a schematic diagram of the a tubular filter for the membrane filtration module shown in FIG. 2.

FIG. 4 is a flow chart showing the various operating modes of the wastewater system as operated by the controller.

FIG. 5 is a flow chart showing the steps of the FILTRATION mode 400 according to an embodiment of the present invention.

FIG. 6 is a flow chart showing the steps of the BACKWASH mode 600 according to an embodiment of the present invention.

FIG. 7 is a flow chart showing the steps of the DRAIN-FLUSH mode 800 according to an embodiment of the present invention.

FIG. 8 is a flow chart showing the steps of the CEC1 mode 900 and the CEC2 mode 1000 according to an embodiment of the present invention.

FIG. 9 is a flow chart showing the steps of the PRESERVATION mode 1100 and the PRESERVATION DRAIN mode 1200 according to an embodiment of the present invention.

FIG. 10 is a schematic diagram of a wastewater system according to another embodiment of the present invention.

FIG. 11 is a schematic diagram of a wastewater system according to yet an embodiment of the present invention.

FIG. 12 is a schematic diagram of a wastewater system according to yet an embodiment of the present invention.

### DETAILED DESCRIPTION

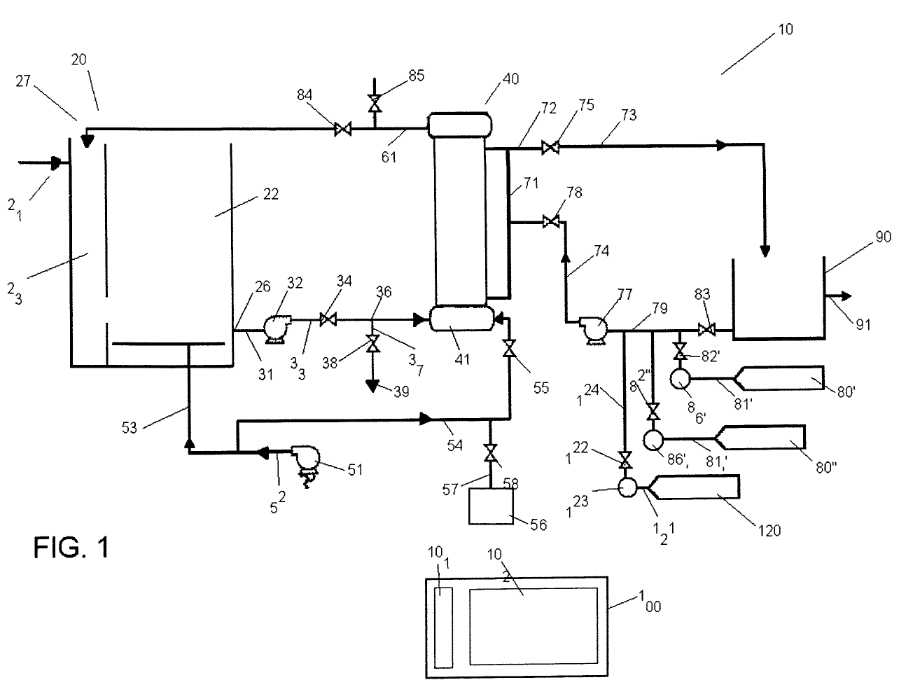

Referring to the Figures, FIGS. 1-3 schematically shows a wastewater system 10 and its components according to an embodiment of the present invention. The system 10 can comprise a bioreactor 20 and one or membrane filtration modules 40. Wastewater (also known as influent) enters the bioreactor 20 at an inlet 21. The bioreactor 20 may include an oxic zone 22, an anoxic zone 23, an anaerobic zone (not shown), or any combination thereof. The anoxic and anaerobic zones can be used for nutrient removal if necessary. The bioreactor can be any one known in the art; for example the bioreactor can be a long sludge age design.

The treated wastewater exits through the outlet 26 and flows through the flow line 31 to a circulation pump 32. The circulation pump 32 pumps the treated wastewater through the flow line 33 and the circulation valve 34 to the diffuser 41 of the membrane filtration module 40. The flow line 33 may also include a T-branch 36 which is connected between the circulation valve 34 and the diffuser 41. The T-branch 36 leads into the flow line 37, through a drain valve 38, and into a drain 39. The circulation valve 34, the drain valve 38, and the drain 39 will be described later in relation to the method of operation according to an embodiment of the present invention.

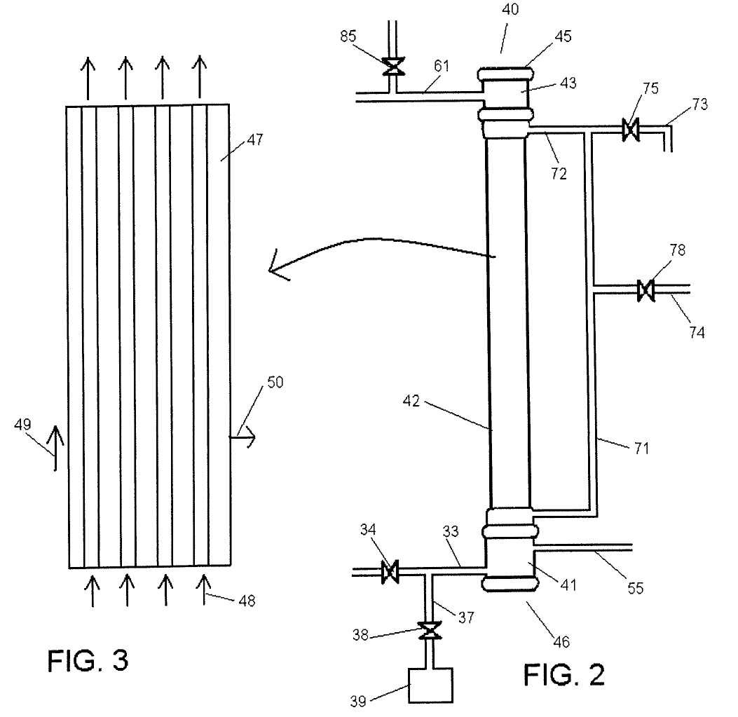

The membrane filtration module 40 is shown in FIG. 2 in which the module 40 can have a distal end 45 and a proximal end 46 and may include a diffuser 41, a housing 42, and a return section 43. The diffuser 41 is connected to the flow line 33 in which the treated wastewater (also known as the “feed liquid”) enters the module 40. The feed liquid is channeled through the diffuser up to the housing 42. The housing 42 includes a plurality of membrane filters 47, such as tubular membranes, in which feed liquid 48 continues to flow up in an axial direction 49 of the tube while cleaned water (also known as the “permeate”) flows in the radial direction 50 from the inside of the tubular membrane through the circumferential surface of the membrane filter towards the opposite side of the circumferential surface. In other words, the feed liquid flows from the proximal end 46 of the module 40 though the membrane filters 47 in the axial direction 49 up to the distal end 45 of the module 40 while the permeate flows from one side of the filters and out an opposite side thereof in the radial direction 50 through the circumferential surfaces of the tubular membranes.

The feed liquid that flows to the distal end 45 of the module 40 enters that return section 43 which includes an outlet connected to a return line 61. The return line 61 is connected to an inlet 27 of the bioreactor 20 for additional processing. In addition, there is a return line control valve 84 in the return line 61, which is opened during the filtration of the feed water such that the flow in the return line 61 is continuous. In the meantime, the permeate exiting the membrane filter 47 flows through the exit lines 71 and 72, which are connected to the circumferential surface of the membrane filtration module 40. For example, the exit lines 71 and 72 could be connected to 2.5 inch diameter ports that are set into the side of each membrane filtration module 40. The exit lines 71 and 72 are in fluid communication with the flow lines 73 and 74.

The flow line 73 includes a permeate control valve 75 which controls the flow of the permeate to the flow line 73. The permeate in the flow line 73 flows into to a storage tank 90 in which the permeate is collected. Once in the tank 90, the permeate may then exit the treatment system 10 as effluent through an outlet 91 for use in industrial, agricultural or other viable applications. The flow line 74 includes a backwash control valve 78 and is connected to a backwash pump 77. The backwash pump 77, in turn, is connected to the storage tank 90 via the flow line 79, which includes a tank control valve 83.

If a backwash process is desired cleaning the inside of the membrane filters, the permeate control valve 75 is closed which prevents permeate from flowing through the flow line 73. The backwash valve 78 is opened to permit fluid flow through the flow line 74. The tank control valve 83 is opened so that the backwash pump 77 and the storage tank 90 are in fluid communication with each other. Meanwhile, the cleaning chemical solution control valves 82′ and 82″ and the preservation solution control valve 122 (to be described later) are closed. The permeate is pumped from the storage tank 90 by the backwash pump 77 through the flow line 74 to the exits lines 71 and 72 in the reverse direction of normal use, i.e., during the filtration mode. The permeate flows from the exit lines 71 and 72 through the membrane filters 47, i.e., permeate is caused to flow from the outside of the membrane filter into the inside of the membrane filter. The permeate can then flow downward toward the proximal end 46 or upward toward the distal end 45. For the flow that flows downward toward the proximal end 46, the backwash flow exits out the diffuser 41 into the flow line 33. During this backwash process, the circulation valve 34 is closed to prevent the permeate from traveling back to the circulation pump while the drain valve 38 is opened. With the drain valve 38 open, the backwashing permeate is permitted to exit the system through the drain 39, for example a six inch diameter pipe. Meanwhile, for the backwash flow that flows upward toward the distal end 45, the backwashing permeate exits out of the return section 43 into the return line 61 and eventually is emptied into the bioreactor 20. Alternatively, the return line control valve 84 on the return line 61 can be closed to prevent the permeate flow from returning to the bioreactor 20. In such an instance, all the backwashing permeate would be channeled into the drain 39.

In some instances, a chemical cleaning of the membrane filters may be desired. In the embodiment shown in FIG. 1, the system is configured to have two chemical cleanings that can involve different cleaning chemical solutions. For a first chemical cleaning, a first cleaning chemical-solution source 80′ can be connected to the flow line 81′, which includes a first cleaning chemical solution control valve 82′ and a first cleaning chemical dosing pump 86′. The flow line 81′ connects to the system at the flow line 79 between the backwash pump 77 and the tank control valve 83. For a second chemical cleaning, a second cleaning solution source 80″ can be connected to the flow line 81″, which includes a second cleaning chemical solution control valve 82″ and a second cleaning chemical dosing pump 86″. The flow line 81″ connects to the system at the flow line 79 between the backwash pump 77 and the tank control valve 83.

When a first chemical cleaning is desired, the permeate control valve 75 is closed which prevents the cleaning chemical solution from flowing through the flow line 73 and into the storage tank 90. The backwash valve 78 is open to permit fluid flow through the flow line 74. The tank control valve 83 is opened, which allows the permeate to be pumped from the storage tank 90 by the backwash pump 77 through the flow line 74. The cleaning chemical solution control valve 82′ is opened and the first cleaning chemical dosing pump 86′ is energized, thus allowing fluid flow from the cleaning chemical solution source 80′ into the flow line 74, and the backwash pump 77. Meanwhile the cleaning chemical solution control valve 82″ is closed, thus allowing no fluid communication among the second cleaning chemical solution source 80″, the flow line 74, and the backwash pump 77. The backwash pump 77 and the first cleaning chemical dosing pump 86′ then pump the first cleaning chemical solution from first cleaning chemical solution source 80′ into the exits lines 72 and 73 in the reverse direction of normal use. The first cleaning chemical solution flows from the exit lines 72 and 73 into the membrane filters 47. The permeate with the first cleaning chemical solution can then flow downward toward the proximal end 46 or upward toward the distal end 45. For the flow that flows downward toward the proximal end, the flow exits out the diffuser 41 into the flow line 33. During the first chemical cleaning process, the circulation valve 34 can be closed to prevent the first cleaning chemical solution from traveling back to the circulation pump 32. Meanwhile, the drain valve 38 can be closed during the chemical soak period (to be described later) or opened when it is desired to allow the first cleaning chemical solution to exit the system through the drain 39 via the flow line 37. For the flow that flows upward toward the distal end 45, the return line control valve 84 can be closed, thus preventing the first cleaning chemical solution to exit out of the return section 43 into the return line 61 leading to the bioreactor 20. In addition, the tank control valve 83 can be open, which allows the permeate to flow into the membrane filtration module 40 along with the cleaning chemicals from the first cleaning chemical source 80′.

When a second chemical cleaning is desired, the permeate control valve 75, the backwash valve 78, and the tank control valve 83 are opened. However, the first cleaning chemical solution control valve 82′ is closed, thus preventing fluid communication among the first cleaning chemical solution source 80′, the flow line 74, and the backwash pump 77. In addition, the first cleaning chemical dosing pump 86′ is not energized but the second cleaning chemical dosing pump 86″ is energized. Meanwhile, the second cleaning chemical solution control valve 82″ is opened, thus allowing fluid communication among the second cleaning chemical solution source 80″, the flow line 74, and the backwash pump 77. The backwash pump 77 and the second cleaning chemical dosing pump 86″ then pump the cleaning chemical solution from second cleaning chemical solution source 80″ into the exits lines 71 and 72 in the reverse direction of normal use. The cleaning chemical solution flows from the exit lines 72 and 73 into the membrane filters 47. The permeate can then flow downward toward the proximal end 46 or upward toward the distal end 45. For the flow that flows downward toward the proximal end, the flow exits out the diffuser 41 into the flow line 33. During the second cleaning chemical cleaning process, the circulation valve 34 is closed to prevent the second cleaning chemical solution from traveling back to the circulation pump 32. Meanwhile, the drain valve 38 can be closed during the chemical soak period (to be described later) or opened when it is desired to allow the second cleaning chemical solution to exit the system through the drain 39 via the flow line 37. For the flow that flows upward toward the distal end 45, the return line control valve 84 can be closed, thus preventing the second cleaning chemical solution to exit out of the return section 43 into the return line 61 leading to the bioreactor 20. In addition, the tank control valve 83 can be open, which allows the permeate to flow into the membrane filtration module 40 along with the cleaning chemicals from the second cleaning chemical source 80″.

In one embodiment, the first and second cleanings can occur at the same time in which both cleaning chemical solution control valves 82′ and 82″ are opened while the first and second cleaning chemical dosing pumps 86′ and 86″ are energized to deliver flow to the backwash pump 77 and the membrane filtration module 40.

Another aspect of the system of FIG. 1 includes an air blower 51 which is connected to air line 52. The air line 52 can be divided into two different airlines: the air line 53 to the bioreactor 20 and the airline 54 to the membrane filtration module 40. The air line 53 provides a source of oxygen to the oxic zones of the bioreactor 20 if necessary.

The air line 54 is connected to the membrane filtration module 40 via the diffuser 41 to introduce air into the membrane filtration module. An air isolation valve 55 is placed in the air line 54 to prevent feed liquid from entering the air line 54. The air flow into the module 40 provides an air lift so that the amount of deposition and accretion of layers on the membranes can be reduced. The air blower 51 can be configured to introduce air continuously or intermittently using a controller 100. In addition, the controller 100 may be configured to automatically adjust the amount of air being blown by the air blower 51 and delivered to the membrane filtration module 40. The adjustment operation may take the form of the controller monitoring one or more membrane operating parameters (such as the pressure inside the membrane filtration module 40, the pressure differential across the membrane, or other operating parameters) and adjusting the amount of air delivery based on the value(s) of the operating parameter(s) according to a predetermined optimum operating condition using one or more control valves (not shown).

According to one embodiment, one or more cleaning devices can be optionally used for flushing the air lines 52, 53, and/or 54 with at least one of a liquid and an air stream so as to remove any particles or other contaminants in the air lines. For example, FIG. 1 shows a cleaning device 56 in fluid communication with the air line 54 via the flow line 57. The cleaning device 56 can be one known in the art and may deliver an air or liquid stream through the flow line 57 to the air line 54 through an open cleaning valve 58 when such a cleaning is desired. A series of valves (not shown) can be connected to the air lines 52, 53, and/or 54 so as to control the flow of the cleaning air or liquid stream through the desired air lines. Thus, the cleaning air or liquid stream may be directed into one or more of the air lines. The air or liquid stream may also exit, for example, out the diffuser 41, out the bioreactor 20, and/or out a drain (not shown). When a cleaning of the air lines is not desired, the cleaning valve 58 is closed, thus preventing flow through the flow line 57 to and from the cleaning device 56.

Another aspect of the system is a controller 100, which can be used to control the flow of fluids throughout the system by controlling one or more of the circulation pump 32, the circulation valve 34, the drain valve 38, the permeate control valve 75, the backwash control valve 78, the backwash pump 77, the tank control valve 83, the cleaning chemical solution control valves 82′ and 82″, the cleaning chemical dosing pumps 86′ and 86″, the return line control valve 84, and the air blower 51. For example, the controller 100 can include all the software and hardware necessary to carry out the method of operating the treatment system 10. The controller 100 also can include one or more subcontrollers 101. Each subcontroller 101 can be used to monitor and control their respective membrane filtration module 40 when more than one membrane filtration module is used. In addition, the controller 100 can include a common controller 102, which can control common resources, such as the cleaning chemical pumps, of the system. In automatic mode, the common controller 102 can control the operation of each subcontroller 101. The subcontroller can perform filtration and backwash based on the flux or filtration rate and filtration time provided by the common controller 102. The subcontroller executes the filtration routine and signals the common controller 102 when a backwash is required. The common controller controls and sequences the backwash across the entire system.

In one embodiment of the present invention, the controller 100 can be used to carry out one or more of the following method steps: interrupting the introduction of the feed liquid into the proximal end 46 of the one or more membrane filtration modules 40; allowing at least a portion of said feed liquid present in the one or more membrane filtration modules 40 to drain therefrom, along with at least a portion of any residue that might have accumulated on the one side of said plurality of membrane filters; flushing the plurality of membrane filters by causing at least a portion of said permeate to flow from the opposite side of the plurality of membrane filters and out the one side thereof or to flow from the one side of said plurality of membrane filters and out the opposite side thereof; introducing a first chemical solution to the one or more membrane filtration modules; introducing a second chemical solution to the one or more membrane filtration modules; and resuming the introduction of the feed liquid to the proximal end 46 of the one or more membrane filtration modules 40.

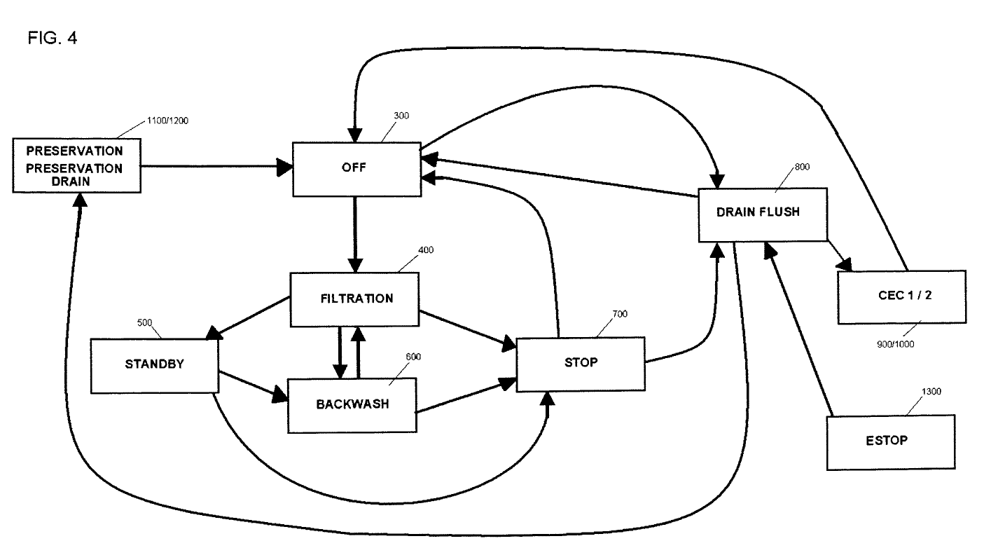

FIG. 4 is flowchart showing that various operating modes of the method and system for operating a membrane bioreactor wastewater treatment system as programmed into and controlled by the controller 100. These modes include: the OFF mode 300, the FILTRATION mode 400, the STANDBY mode 500, the BACKWASH mode 600, the STOP mode 700, the DRAIN-FLUSH mode 800, the CEC1 mode 900, the CEC2 mode 1000, the PRESERVATION mode 1100, the PRESERVATION DRAIN mode 1200, and the ESTOP mode 1300. Each of these modes will be discussed in turn below.

The OFF Mode 300

The OFF mode 300 is the default operating mode and occurs when the system is out of service. All the valves are closed and all the devices are de-energized. In addition, The OFF mode 300 is the default program state and the fail-safe operating mode in the event of a critical alarm, which can be activated by the controller 100 or manually by the operator. Furthermore, care should be taken that the system does not remain in the OFF mode 300 for extended periods of time without proper cleaning or preservation. An alarm can be provided to alert the operator if such a circumstance has occurred.

The FILTRATION Mode 400

From the OFF mode 300 (or the BACKWASH mode 600 to be described later), the system can go into the FILTRATION mode 400, which produces the treated effluent (or permeate) that is collected in the storage tank 90. The FILTRATION mode is controlled by the controller 100 and, once started, the system will continue to run automatically until stopped by the operator or a critical system alarm.

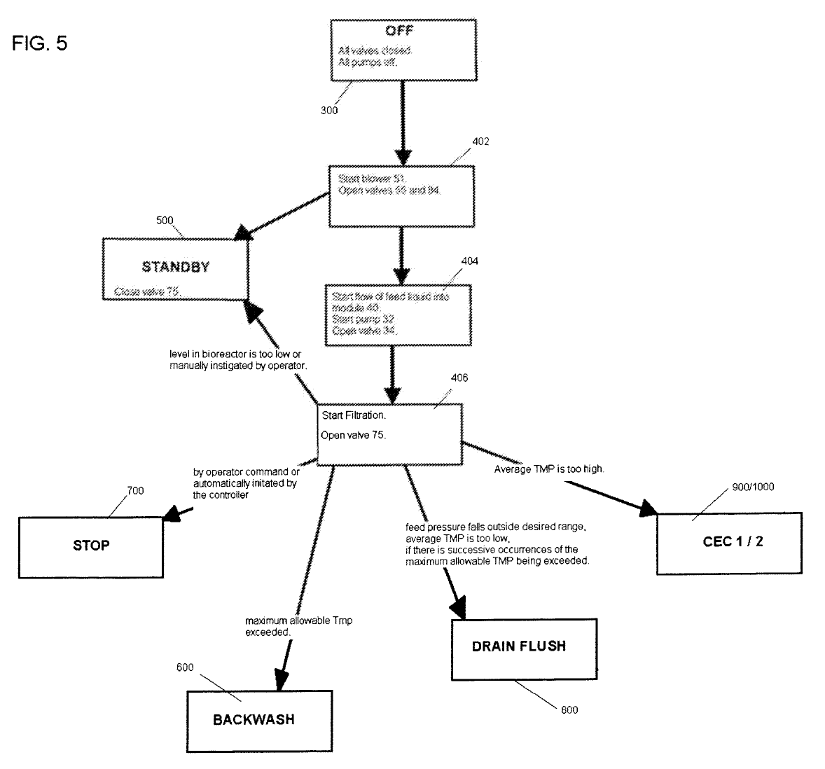

FIG. 5 is a flow chart showing the steps of the FILTRATION mode 400 according to an embodiment of the present invention. The mode begins at step 402 with the start up of the air flow in which the air blower 51 is started and the air isolation valve 55 and the return line control valve 84 are opened. A brief time lag is provided to assure that the air blower 51 has reached operating speed and pressure and displaced all the fluid from the air line 54.

The next step 404 is the start up of the flow of the feed liquid in which the circulation pump 32 (controlled by the controller 100) is started and the treated wastewater (the feed liquid) flows into the flow line 33, through the open circulation valve 34 and into the diffuser 41. The drain valve 38, the permeate control valve 75, and the backwash control valve 78 are all closed such that the flow of the feed fluid only goes through the membrane module 40, through the feed line 61 and the open return line control valve 84, and back into the bioreactor 20.

Once again, another short time delay is provided to assure that a two-phase flow is fully developed in the system. Filtration commences at step 406 where the permeate control valve 75 is opened after this delay. Thus, two phase flow is established which travels up the length of the membrane module 40 such that effluent passes through the membrane walls of the membrane filters 47 while biological solids are collected on the membrane surface. Air bubbles caused by the air introduced through the air line 54 scour the surface of the membrane filters to maintain system performance. Filtration is performed for a fixed time period, which can typically range, for example, from 5 to 15 minutes and can be adjusted by the operator through the controller 100.

The FILTRATION mode can be primarily controlled via the controller 100 in which the filtration rate and time can be set based on the liquid level in the reactor 20. Alternatively, the operator can operate the system manually by directly setting the filtration rate and time on the controller 100. In such a condition, the controller display will indicated a “manual override” condition.

The filtration can be performed for a fixed period of time. At the end of the filtration time, the system can automatically perform a BACKWASH mode 600 (to be described later). The automatic backwash cycles are coordinated by the controller 100. Alternatively, the operator may also manually call for the BACKWASH mode from with the controller at any time. Furthermore, the operator may also end the FILTRATION mode by issuing a stop command, i.e., instigating the STOP mode 700 (to be described later).

During filtration, the pressure differential across the membrane, known as the trans-membrane pressure (or TMP), is constantly monitored and recorded. The TMP dictates the differential force required to push the permeate across the membrane. When fouling or plugging increases, the TMP also increases. The TMP is calculated by averaging the feed side pressure in the diffuser 41 and the return section 43 minus the pressure in the flow lines 71 and 72. Normal TMP can range from 0.2 to 4 psi. The maximum allowable TMP limits the feed pressure in the system. If the maximum allowable TMP is exceeded, the system will include an alarm that will be triggered and the system will be automatically backwashed, i.e., the BACKWASH mode 600 will be instigated. If there is a succession of these occurrences, the controller 100 will automatically trigger the DRAIN-FLUSH mode 800.

When monitoring the TMP, the controller 100 can record the running 1-min average TMP (hereinafter referred to as the average TMP) during filtration to monitor long-term system performance. This parameter can reset with each filtration cycle. The monitoring can be performed by comparing the average TMP with operator set limits. If the average TMP is too low, a “Low TMP” alarm can be triggered and the system can automatically execute a drain-flush procedure, i.e., the DRAIN-FLUSH mode 800. If the average TMP is too high, a chemical cleaning is required and a “cleaning required” alarm can be triggered. It should be noted that a different running average can be used instead of the 1-min average.

Besides monitoring the average TMP, the controller 100 can also monitor the high and low feed pressure at the diffuser 41 to assure proper circulation flow and prevent accumulation of debris at the membrane module inlet. If the feed pressure at the diffuser 41 falls outside a desired range, an alarm condition is automatically triggered and the DRAIN-FLUSH mode 800 can be started.

Table 1 shows a listing of exemplary operating parameters for the filtration process but others can be used.

TABLE 1
Operating Parameters for FILTRATION mode

| Operating Parameter | Operating Range | Comments |
|---|---|---|
| Gross Flux (gfd) | 15.0–32.0 | Flux through the membrane. Operator |
| (Average Flow) | (25) | selectable or bioreactor level |
| | | controlled. |
| Average Filtrate Flow (gpm) | 32.5–69.3 | Permeate production per membrane |
| (Peak Flow) | (54.2) | filtration module |
| Min. Circulation Flow (gpm) | 880 | Flow of feed liquid into module 40. |
| | | Can use constant speed pumps. Manual |
| | | pump selection and adjustment. |
| Circulation Pressure loss (psi) | 0.5–2.0 | @5 cP viscosity @880 gpm circulation |
| | | rate. Excludes static head losses. |
| Anticipated TMP (psi) | 0.0–4.0 | |
| Min. Air Flow Rate (scfm) | 12 | Can use constant speed blowers. |
| | | Manual blower selection and |
| | | adjustment. |
| Filtration Duration (min.) | 5–15 | |

The STANDBY Mode 500

The STANDBY mode 500 is entered when the bioreactor level drops below a predetermined minimum level. Thus, the system is allowed to remain offline, i.e., no permeate is produced, but ready for service.

An adjustable delay, such as 1-20 minutes, can be put into place to prevent unnecessary cycling of the system. When the STANDBY mode is ordered by the controller, the current FILTRATION mode will be carried to completion first before entering the STANDBY mode. Also, the operator may manually set the STANDBY mode from the controller 100. The STANDBY operation can be terminated when the bioreactor level is increased above the predetermined minimum level.

During the STANDBY mode 500, the controller maintains the circulation of the feed liquid and the air flow while the permeate production is stopped; thus, the filtration rate is set to zero. Therefore, the circulation pump 32 and the air blower 51 are operating; the circulation valve 34, the air isolation valve 55, and the return line control valve 84 are opened; and the permeate control valve 75 and the backwash control valve 78 are closed.

The circulation of the feed liquid and the air flow through the system during the STANDBY mode ensure that solids do not accumulate on the membrane surface even though the flow of permeate through the flow lines 71 and 72 is stopped (by the closure of the permeate control valve 75). As a result, all alarms and other process conditions from the FILTRATION mode are maintained as shown in Table 2.

TABLE 2
Operating Parameters for FILTRATION mode

| Operating Parameter | Operating Range | Comments |
|---|---|---|
| BGross Flux (gfd) | 0 | Filtration is terminated. |
| Average Filtrate Flow (gpm) | 0 | Permeate production is terminated. |
| Min. circulation Flow (gpm) | 880 | Held by the controller 100. Can use |
| | | constant speed pumps. Manual pump |
| | | selection and adjustment. |
| Circulation Pressure loss (psi) | 0.5–2.0 | @ 5 cP viscosity @ 880 gpm |
| | | circulation rate. Excludes static head |
| | | losses. |
| Maximum Feed Pressure (psi) | <6 psi | |
| Min. Air Flow Rate (scfm) | 12 | Held by the controller 100. Can use |
| | | constant speed blowers. Manual |
| | | blower selection and adjustment. |

The membrane filtration module 40 may be automatically returned to service by the controller 100 based on the liquid level in the bioreactor 20 (i.e., the liquid level in the bioreactor has increased to an acceptable level) or manually returned to service by the operator via the controller 100. In such a case, a backwash (see the BACKWASH mode below) can be automatically performed on each membrane filtration module 40 before it is returned to service and the filtration timer is re-set to zero.

The BACKWASH Mode 600

The BACKWASH mode 600 is performed at the end of each filtration cycle (the FILTRATION mode 400) to maintain system performance. The mode physically removes biological solids that have accumulated on the membrane surface by reversing the permeate flow through the membranes. In addition, a backwash is also performed if the membrane filtration module 40 was in the STANDBY mode.

The controller 100 coordinates and maintains the required backwash interval for all operating membrane modules 40. The BACKWASH mode 600 can only be entered from the FILTRATION mode or the STANDBY mode because the feed flow circulation and the airflow are required for the sequence.

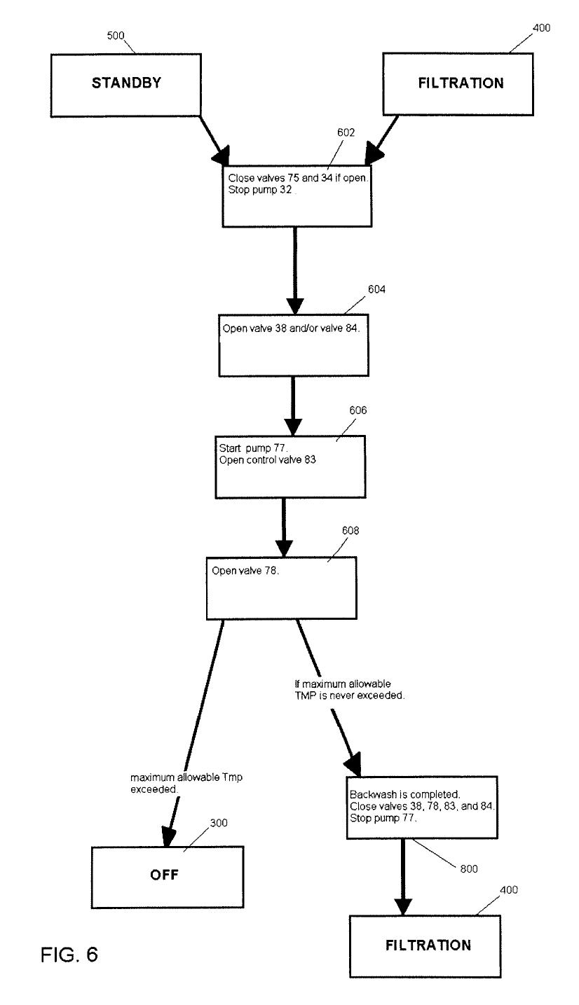

FIG. 6 is a flow chart showing the steps of the BACKWASH mode 600 according to an embodiment of the present invention. Although not depicted in FIG. 6, the air flow flowing through the membrane module from the air blower 51 via the airline 54 can flow during the BACKWASH mode 600 in order to aid in the scouring process for removing the residue (such as solids) that has accumulated in the membrane filtration module 40.

The BACKWASH mode 600 commences by stopping the permeate flow by closing the permeate control valve 75, if necessary, at step 602. In addition, the circulation valve 34 is closed and the circulation pump 32 is stopped. In one embodiment, the return line control valve 84 can be closed and the drain valve 38 can be opened at step 604 such that the flow of the backwash only travels into the flow lines 72 and 71; through the diffuser 41, the flow line 33, the flow line 37, and the drain valve 38; and into the drain 39. In another embodiment, the return line control valve 84 can be opened and the drain valve 38 can be closed at step 604 such that the flow of the backwash only travels into the flow lines 72 and 71; through the returning section 42, the return line 61, and the return line control valve 84; and into the bioreactor 20. In yet another embodiment, the return line control valve 84 and the drain valve 38 can be opened at step 604 such that the flow of the backwash travels to both the bioreactor 20 and the drain 39.

After the permeate control valve 75 and the circulation valve 34 are closed, the backwash control valve 78 is also closed and the backwashing pump 77 starts pumping at step 606. In one embodiment, the backwashing apparatus may include a plurality of backwashing pumps 77. For example, the system may comprise three pumps to be used as the backwash pump 77. In such an instance, two pumps may be duty pumps that each can deliver 50% of the backwash flow while a third pump can be a standby. Thus, in this embodiment, upon start up of the backwashing, two of the three available backwash pumps 77 are started. In another embodiment, a single backwashing pump 77 may be sufficient in which, upon the start up of the BACKWASH mode, the single backwashing pump 77 is started.

The source of the backwash flow comes from the permeate stored in the storage tank 90. When the backwash pump 77 is started, the tank control valve 83 is opened and the permeate from storage tank 90 goes into fluid communication with the backwash pump(s) 77. It is noted that the cleaning chemical solution control valves 82′ and 82″ remain closed (as was the case in the FILTRATION mode 400) such that the permeate flowing in the flow line 79 are isolated from the cleaning chemical solutions in the cleaning chemical solution sources 80′ and 80″. Once the backwashing pump 77 has started, the backwashing pump(s) 77 are allowed to run for a brief time delay to reach full operating speed and pressure. The backwash control valve 78 (which has been closed) is now opened at step 608 and flow is allowed for a set time period. It is noted that because the permeate control valve 75 is closed, there is no fluid flow into the flow line 73.

As previously mentioned, the backwashing process proceeds in which permeate from the storage tank 90 is pumped by the backwash pump 77 into fluid lines 71 and 72 and then into the membrane filtration module 40 in the reverse direction of the filtration flow (or normal use mode). The rushing of permeate into the membrane filters 47 dislodges the accumulated plugs in the membranes, and thus unclogs the filters 47. The backwash can then exit through the diffuser 41 and end up in the drain 39 and/or exit through the returning section 43 and end up in the bioreactor 20. An example of exemplary operating parameters are provided in Table 3 below, although these parameters can be changed based on desired operational efficiency or desired output.

TABLE 3
Operating Parameters for BACKWASH mode

| | Operating | |
|---|---|---|
| Operating Parameter | Range | Comments |
| Backwash Flux (gfd) | 176 | Flux of permeate through the |
| | | membrane. Constant flux is |
| | | desirable. |
| Backwash flow (gpm) | 383 | Per membrane filtration module 40 |
| Backwash Duration (s) | 5–15 | Operator adjustable |
| Anticipated Backwash | 9.0–14.0 | @ 50° F. |
| TMP (psi) | | |
| Maximum Backwash | 14.7 | |
| TMP (psi) | | |

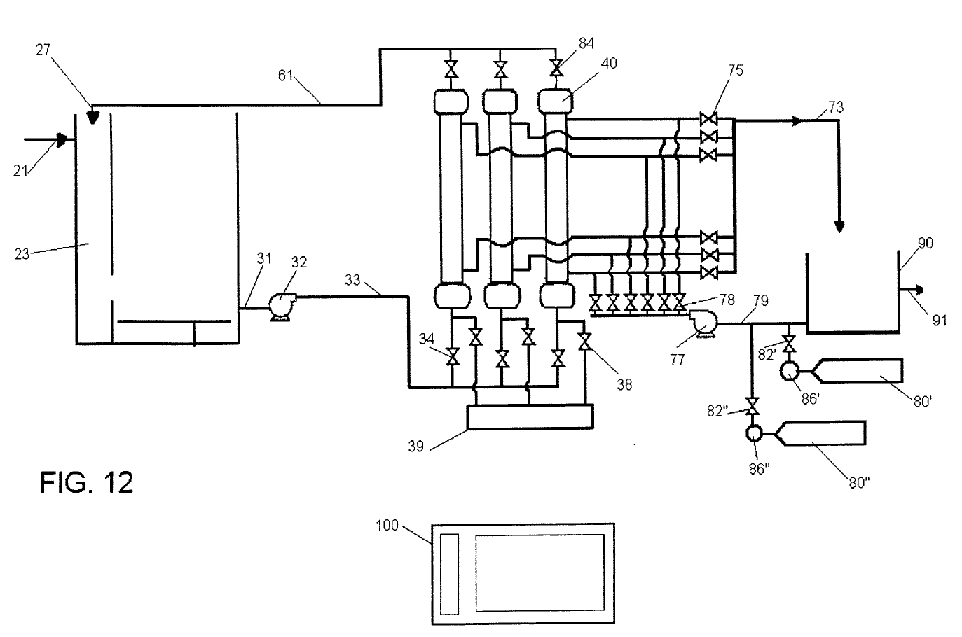

The backwash can be initiated either by an unacceptable TMP condition or automatically based on the completion of the time period for the FILTRATION mode. If the backwash is automatically initiated, it would first perform the backwash on the longest running membrane filtration module 40 (if there is more than one as seen in FIG. 12). In such a case, the controller can be configured to backwash all the remaining modules 40 in sequence (regardless of their current run-time) so as to effectively reset the backwash sequence for the entire system and ensure that the equipment is operated efficiently. If the backwash is based on an unacceptable TMP condition of a single membrane filtration module 40 (if there is more than one), the backwash will be performed on the particular membrane filtration module 40 that suffers from the unacceptable TMP condition and will rest the filtration time on that particular membrane filtration module 40. In this case, the controller would not need to perform a backwash on the remaining membrane filtration modules 40.

During the process of backwashing, the operating pressure can be an important factor and may be continuously monitored. The system will exhibit a negative TMP during the BACKWASH mode because the flow is reversed through the membrane filtration module 40, i.e., the pressure will be highest on the permeate side (flow lines 71 and 72) of the membrane filtration module 40. The maximum allowable TMP during the BACKWASH mode can be set so as to prevent permanent damage to the membranes. For example, in one embodiment, the maximum allowable TMP can be 14.7 psi. In this case, if the maximum allowable TMP is exceeded, an alarm can be issued, which can shut down the system (i.e., the OFF mode 300 is instigated) and alert to the operator of the alarm condition.

Once the backwash is complete, the backwash pump 77 is shut off; the backwash control valve 78, the drain valve 38, the tank control valve 83, and the return line control valve 84 are closed; and the FILTRATION mode 400 as seen in FIG. 5 is reinitiated.

The STOP Mode 700

The STOP mode 700 activates the shutdown sequence for the membrane filtration module 40 and is the method in which the membrane filtration module 40 enters the OFF mode 300. Thus, all the control valves are closed and all the pumps and the air blower are stopped. The STOP mode is provided to allow the operator to interrupt service for a brief period of time to perform maintenance before returning the membrane filtration module to service. In one embodiment, the membrane filtration module 40 should not be stopped for more than a predetermined time, for example 5 to 10 minutes, before a flushing operation is instigated. For example, the controller can issue an alarm if a membrane filtration module 40 is stopped from more than 5 minutes and will automatically perform the DRAIN-FLUSH mode 800 after 10 minutes. The alarm will remain until it is manually cleared by the operator.

The STOP mode can be instigated from the FILTRATION, STANDBY, or BACKWASH modes as shown in FIG. 1. If the STOP mode is instigated during the BACKWASH mode, the backwash sequence will be completed on the particular membrane filtration module 40 before stopping. Additionally, the STOP mode can be called during selected general alarm conditions. These conditions can include one or more of the following: a low-level permeate tank alarm, a circulation pump failure alarm, an air blower failure alarm, and a low level of cleaning chemical alarm. Once in the STOP mode, the permeate flow is terminated by closing the permeate control valve 75 (if not closed already), terminating the circulation pump 32 (if not terminated already), and the circulation control valve 34 is closed (if not closed already). The air blower 51 can be allowed to run for a brief time before closing the air isolation valve 55 and turning off the air blower 51.

The DRAIN-FLUSH Mode 800

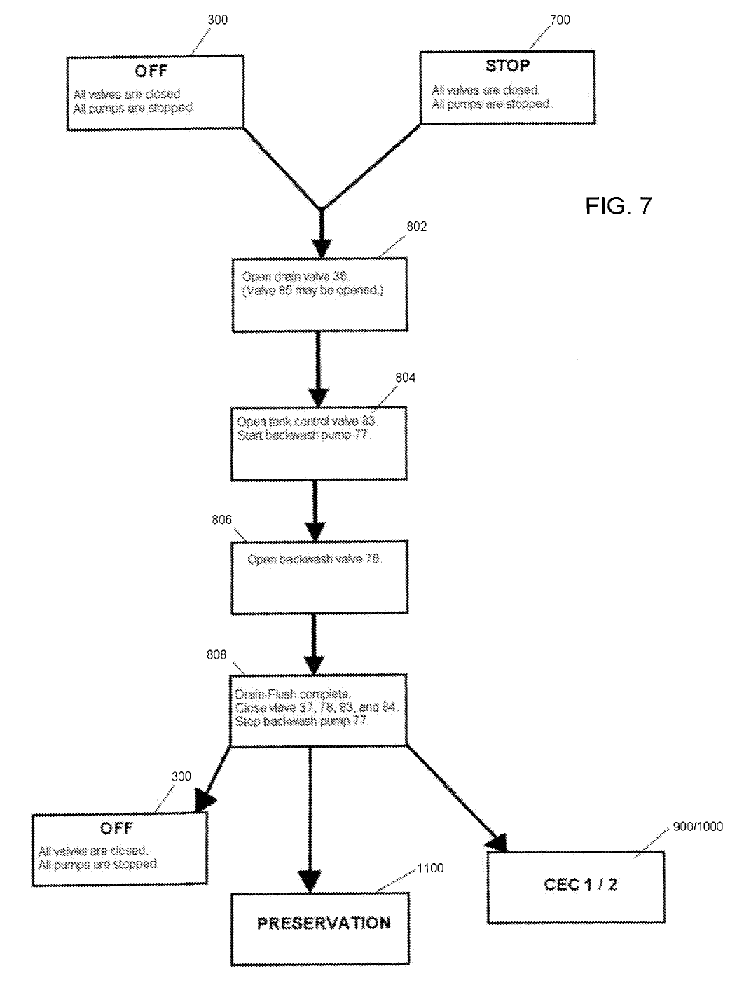

The DRAIN-FLUSH mode 800 is performed to remove accumulated solids from the membrane filtration module 40. This mode may be automatically performed at a set interval by the controller 100, performed under selected alarm conditions (such as a high TMP or low TMP), or manually initiated by the operator. If done automatically, the controller can start the mode at predetermined intervals which can range, for example from once every hour to up to once every six hours. The DRAIN-FLUSH may only be activated after the membrane filtration modules 40 are in or have passed through the OFF mode 300 or STOP mode 700 because all the fluid in each membrane filtration module 40 is purged during the sequence. FIG. 7 is a flow chart showing the steps of the DRAIN-FLUSH mode 800 according to an embodiment of the present invention.

Thus, at the onset of the DRAIN-FLUSH mode, the circulation pump 32 is not running and the circulation valve 34 is closed as well as the backwash pump 77 and the cleaning chemical dosing pumps 86′ and 86″ are off and the control valves 75, 82′, and 82″ are closed. The drain valve 38 is opened at step 802 and the membrane filtration module is allowed to drain in the drain 39 for a set period of time. In one embodiment, the drain can be caused by gravity. Optionally, a dedicated venting valve 85 that leads to a vent positioned above the membrane filtration module can be located on the return line 64 (seen in FIG. 1). The venting valve 85 remains closed during all other modes but is opened during the DRAIN-FLUSH mode 800. Although not depicted in FIG. 7, the air flow flowing through the membrane filtration module from the air blower 51 via the airline 54 can shut off during the draining process (step 802) by shutting off the air blower 51 and/or closing the air isolation valve 54. Alternatively, the air blower 51 can be operating with the air isolation valve 54 open so as to provide scouring air during the draining process.

Once the gravity drain is complete, one or more flushing sequences can be performed using the backwash equipment. The flushing procedure removes all materials from the feed side of the membranes and these materials can be allowed to gravity drain from the system. At the outset of the flushing procedure, i.e., during the draining of the membrane filtration module, the permeate control valve 75, the backwash control valve 78, the cleaning chemical solution control valves 82′ and 82″, the tank control valve 83, and the circulation valve 34 are closed and the circulation pump 32 is stopped. The venting control valve 85 and the drain valve 38 are open in step 802.

After or during the draining process in step 802, the tank control valve 83 is opened and the backwashing pump 77 starts pumping at step 804. As previously mentioned, the backwashing apparatus may or may not include a plurality of backwashing pumps 77 depending on the operating parameters. When the pump 77 is started and the tank control valve 83 is opened, the permeate from storage tank 90 goes into fluid communication with the backwash pump 77. Once the backwashing pump 77 has started, the backwashing pump 77 is allowed to run for a brief time delay to reach full operating speed and pressure. The backwash control valve 78 (which has been closed) is now opened in step 806 and a flushing flow is allowed for a set time period. Although not depicted in FIG. 7, the air flow flowing through the membrane filtration module from the air blower 51 via the airline 54 can flow during the flushing process in step 806 by starting the air blower 51 and opening the air isolation valve 54. Alternatively, the air flow can remain shut off during the flushing process by keeping the air blower 51 shut off and/or keeping the air isolation valve closed.

As previously mentioned, the backwashing or flushing process proceeds in which permeate from the storage tank 90 is pumped by the backwash pump 77 into fluid lines 71 and 72 and then into the membrane filtration module 40 in the reverse direction of the filtration (or normal use mode). This flushing can occur during or after at least of a portion of the feed liquid has been allowed to drain. The rushing of permeate into the membrane filters 47 dislodging the accumulated plugs in the membranes, and thus unclogging the filters 47. The effective amount of permeate that can be used for the flushing process can vary according to need. For example, the effective amount of permeate during the flushing process can range from about 0.05× to about 10× of the total volume of the membrane filtration module 40. As with the case of the BACKWASH mode 600, the return line control valve 84 can be closed and the drain valve 38 can be opened such that the flow goes into the drain 39 and/or the return line control valve 84 can be opened and the drain valve 38 can be closed such that the flow goes into the bioreactor 20.

An example of exemplary operating parameters are provided in Table 4 below, even though these parameters can be changed based on desired operational efficiency or desired output. The rest of the operating parameters can be similar to Table 3 for the BACKWASH mode.

TABLE 4
Operating Parameters for DRAIN-FLUSH mode

| | Operating | |
|---|---|---|
| Operating Parameter | Range | Comments |
| Drain Duration (s) | 10–60 | Based on system configuration. |
| Flush Interval (days) | 1–30 | Operator adjustable |
| Flush Backwash Flow | 383 | Can use two backwash pumps, if |
| (gpm) | | applicable. |
| Flush Backwash Flux (gfd) | 176 | Can use two backwash pumps, if |
| | | applicable. |
| Flush Duration (s) | 0–60 | Operator adjustable |

The controller 100 can be configured such that, once the DRAIN-FLUSH mode has been initiated, the mode will proceed to completion unless the ESTOP mode is called. Once the DRAIN-FLUSH mode is complete, the membrane filtration module may proceed to the OFF mode 300, the CEC1 mode 900, the CEC2 mode 1000, or the PRESERVATION mode 1100.

The CEC1 Mode 900 and CEC2 Mode 1000

Periodically, the membrane filters must be chemically cleaned to remove fouling materials that have adsorbed or absorbed in the membrane surface. Cleaning may be performed at regular intervals (monitored by the controller 100) or once when the system performance has reached certain operating limits. For example, the cleaning can be performed at regular intervals ranging from 30 days to six months. The CEC1 mode and the CEC2 mode can be separate routines to simplify and automate chemical cleaning process. The operator may be required to prepare the cleaning chemical solutions for the procedure and activate the CEC1/CEC2 modes. Once activated the entire CEC1/CEC2 mode is executed without operator intervention.

In a typical application, two successive cleanings can be performed in which the CEC1 mode is performed using a weak sodium hypochloride solution followed by the CEC2 mode, which is performed using citric acid solution. This two step cleanings ensures that both organic and inorganic materials are removed from the membranes.

However, other embodiments of the cleaning process are also contemplated. For example, the first and second cleaning solutions are not limited to just sodium hypochloride and citric acid solutions. The first and second cleaning solutions can comprise a hypochlorite, an acid, a caustic, a surfactant, or any combination thereof

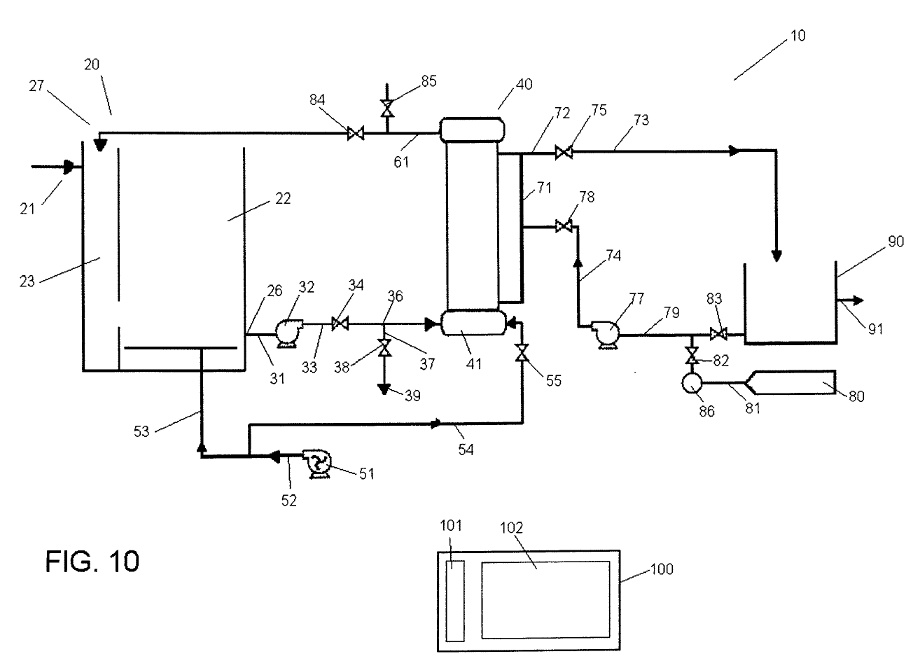

In another embodiment, only one chemical cleaning mode (CEC1) can be used without a second chemical cleaning mode (CEC2). In such an instance, only one cleaning chemical source 80 connected by the flow line 81, one cleaning chemical solution control valve 82, and one cleaning chemical dosing pump 86 are required, such as seen in FIG. 10.

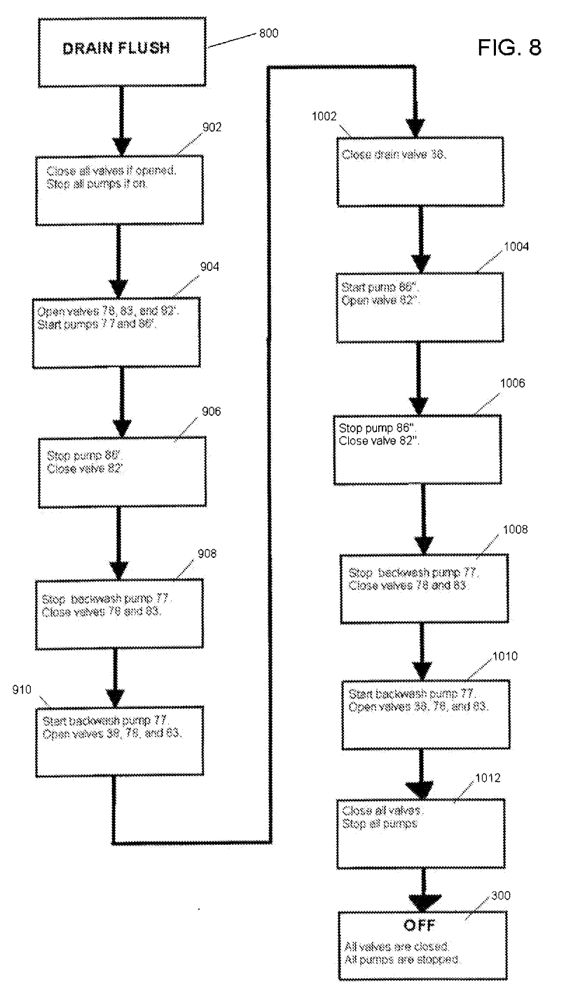

FIG. 8 is a flow chart showing the steps of the CEC1 mode 900 and the CEC2 mode 1000 according to an embodiment of the present invention. The CEC1 and/or CEC2 modes can automatically make use of the DRAIN-FLUSH mode in order to maximize the effectiveness of the chemical reactions and properly purge spent cleaning chemical solutions from the membrane filtration module 40. Thus, the CEC1 mode can commence with an automatic DRAIN-FLUSH mode 800. Once the DRAIN-FLUSH mode 800 is complete, the membrane filtration module 40 can be completely isolated by closing all valves (the circulation valve 32, the return line control valve 84, the drain valve 38, the permeate control valve 75, the backwash control valve 78, and the cleaning chemical solution control valves 82′ and 82″) as seen in step 902. In addition, the CEC1 and CEC2 modes can be started immediately after the FILTRATION mode 400 (such as in the case of a high TMP) or after the BACKWASH mode 600, if desired. During the CEC1 and/CEC2 modes, the air flow from air blower 51 via air line 54 can be shut off by not running the air blower 51 and/or closing the air isolation valve 55.

To commence the CEC1 mode, the backwash control valve 78 is opened; the backwash pump 77 is energized; and the tank control valve 83 is opened in step 904. As a result, permeate is permitted to flow from the storage tank 90 through the backwash pump 77 through the backwash control valve 78, and into the membrane filtration module 40 in the reverse direction of normal flow. As previously mentioned, the backwash pump 77 can include more than one pump, for example three pumps can be used. In view of this, the number of backwash pumps 77 may be one or more for the CEC1 mode. Simultaneously, the first cleaning chemical dosing pump 86′ is energized and the first cleaning chemical solution control valve 82′ is opened. The cleaning chemicals from the first cleaning chemical source 80′ are dosed directly into the backwash flow for a set period of time so as to fill the membrane filtration module 40. After the set period of time, the cleaning chemical dosing pump 86′ is de-energized and the first cleaning chemical solution control valve 82′ is closed in step 906. The permeate is allowed to continue for a brief period after the cleaning chemical dosing is complete during step 906 (known as the CEC Post Dosing Backwash Flow step) to flush the first cleaning chemical solution out of the backwash piping, i.e., flow lines 71, 74, and 79, and into the membrane filtration module 40. After this period of time, the backwash pump 77 is turned off and the backwash control valve 78 is closed in step 908.

The membrane filtration module 40 is permitted to soak for a period of time during step 908 (known as the CEC Chemical Soak step), which can be operator set or set by the controller 100. At the conclusion of the soaking time, another backwash step (known as the CEC Backwash Flow step) can be performed which flushes out the first cleaning chemical solution from the membrane filtration module 40. Thus, the backwash pump 77 is turned on and the backwash control valve 78 and the tank control valve 83 are opened such that the permeate is in fluid communication with the backwash pump 77. Meanwhile, the drain valve 38 can be opened such that the first cleaning solution will flow out of the membrane filtration module 40 via the diffuser 41, into the flow line 33 and the drain valve 38, and exit out the drain 39.

After the CEC1 mode, the CEC2 mode may commence in which, after the flushing in step 910, the drain valve 38 is closed, the backwash control valve 78 remains open as well as the backwash pump 78 remaining energized and the tank control valve 83 remains opened at step 1002. Thus, permeate is still permitted to flow from the storage tank 90 through the backwash pump 77 through the backwash control valve 78, and into the membrane filtration module 40 in the reverse direction of normal flow. The second cleaning chemical dosing pump 86″ is energized and the second cleaning chemical solution control valve 82″ is opened at step 1004. The cleaning chemicals from the second cleaning chemical source 80″ are dosed directly into the backwash flow for a set period of time so as to fill the membrane filtration module 40. After the set period of time, the cleaning chemical dosing pump 86″ is de-energized and the second cleaning chemical solution control valve 82″ is closed at step 1006. The permeate is allowed to continue for a brief period after the cleaning chemical dosing is complete to flush the second cleaning chemical solution out of the backwash piping, i.e., flow lines 71, 74, and 79, and into the membrane filtration module 40. After this period of time, the backwash pump 77 is turned off and the backwash control valve 78 and the tank control valve 83 are closed at step 1008.

The membrane filtration module 40 is permitted to soak for a period of time during step 1008 (the CEC Chemical Soak step), which can be operator set or set by the controller 100. At the conclusion of the soaking time, another backwash step can be performed (the CEC Backwash Flow step) which flushes out the second cleaning chemical solution from the membrane filtration module 40 at step 1010. Thus, the backwash pump 77 is turned on and the backwash control valve 78 and the tank control valve 83 are opened such that the permeate is in fluid communication with the pump 77. Meanwhile, the drain valve 38 can be opened such that the second cleaning solution will flow out of the membrane filtration module 40 via the diffuser 41, into the flow line 33 and the drain valve 38, and exit out the drain 39. After the backwash or flushing step 1010 is performed, all pumps are stopped and all control valves are closed in step 1012.

In an alternative embodiment, the CEC1 and CEC2 modes can be performed simultaneously. In yet another embodiment, only one of the CEC1 and CEC2 modes need be operated during the cleaning cycle.

An example of exemplary operating parameters of the CEC1 and CEC2 modes of operation are provided in Table 5 below. As with the operating parameters provided in the other modes, these parameters are examples only and other parameters can be used based on the desired operational efficiency or desired output of the system.

TABLE 5
Operating Parameters for CEC1 and CEC2 modes

| Operating Parameter | Operating Range | Comments |
|---|---|---|
| CEC Chemical Dosing Bulk Flow | 191 | Only one backwash pump need be |
| (gpm) | | used. |
| CEC Chemical Dosing Bulk Flux | 88 | Only one backwash pump need be |
| (gfd) | | used. |
| CEC Chemical Dosing Duration | 90–120 | Varies based on chemical. |
| (s) | | |
| CEC1 Chemical Concentration | 10,000 mg/l | Alternate chemicals or |
| | Cirtic Acid | concentrations may be used within |
| | | the membrane limits. |
| CEC2 Chemical Concentration | 200 mg/l as free Cl₂ | Alternate chemicals or |
| | | concentrations may be used within |
| | | the membrane limits. |
| CEC Post Dosing Backwash Flow | 191 | Only one backwash pump need be |
| (gpm) | | used. |
| CEC Post Dosing Backwash | 1–15 | Changeable based on system |
| Duration (s) | | configuration |
| CEC Chemical Soak period (min) | 60–120 | Selected by Operator or controller |
| CEC Backwash Flow (gpm) | 383 | |
| CEC Backwash Flux (gfd) | 176 | |
| CEC Backwash Flow duration (s) | 30–120 | Based on system configuration |
| CEC drain time (s) | 10–60 | Based on system configuration |

In another embodiment, an optional draining step can be initiated after the CEC Backwash Flow step for CEC1 or CEC2 mode (i.e., after step 910 or step 1010). This optional a draining step (known as the CEC Draining step) can be performed in which all valves are closed (control valves 34, 75, 78, 82′, 82″, and 84) except the drain valve 38 and optional venting valve 85 and all pumps are stopped. Thus, the membrane filtration module 40 is permitted to gravity drain such that any remaining cleaning chemical solutions from the CEC1 or CEC2 mode can drain from the membrane filtration module 40 out the diffuser 41, into the line 37, and out the drain 39. This optional CEC Draining step can be performed for about 1-15 second before the drain valve (and the venting valve 85 if applicable) are closed in step 1012, then the OFF mode 300 is initiated, which can lead to the FILTRATION mode 400.

The PRESERVATION Mode 1100

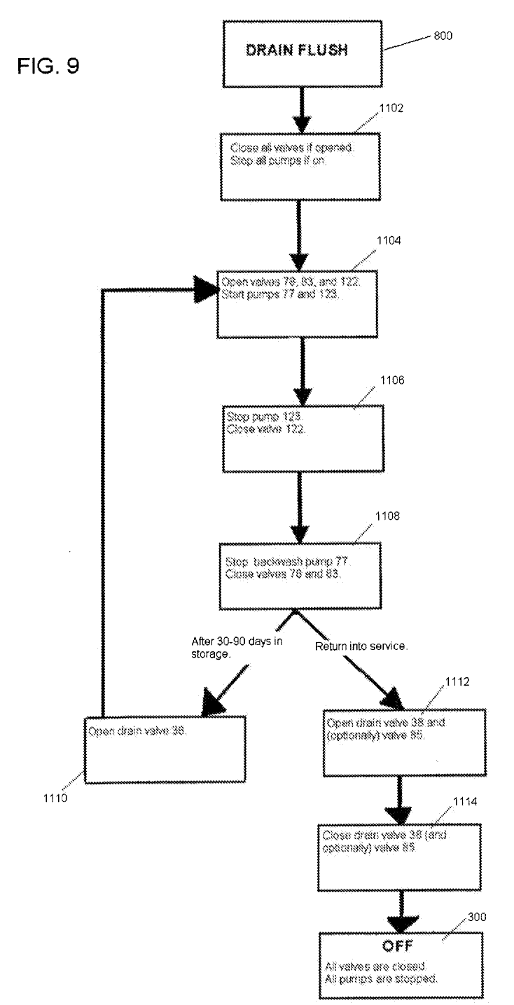

Periodically one or more membrane filtration modules 40 may be removed from service for an extended period of time. During such times, the membranes should be cleaned and preserved to prevent damage. The PRESERVATION mode 110 provides the operator with a semi-automatic means of completing this process. The PRESERVATION mode can be initiated by the operator. FIG. 9 is a flow chart showing the steps of the PRESERVATION mode 1100 and the PRESERVATION DRAIN mode 1200. During the PRESERVATION mode 1100 and the PRESERVATION DRAIN mode 1200, the air flow from air blower 51 via air line 54 can be shut off by not running the air blower 51 and/or closing the air isolation valve 55.

After the operator initiates the PRESERVATION mode 1100, a regular drain-flush sequence is performed as presented above in the DRAIN-FLUSH mode 800 to remove all materials from the membrane filtration module 40. The membrane filtration module 40 can be isolated from service (if there is more than one in the system as seen in FIG. 12) and a preservation chemical solution is introduced via the backwash system, i.e., the backwash pump 77 and the backwash control valve 78, in functionally the same way as in the CEC1 or CEC2 modes. In other words, the PRESERVATION mode operates in a similar manner as the CEC1 or CEC2 modes with the exception that the soak duration is the PRESERVATION mode is indefinite.

FIG. 1 shows an embodiment of the system 10 in which there is a preservation chemical source 120 with a flow line 121 connecting the preservation chemical source 120 to a preservation chemical dosing pump 123. A flow line 124 can connect the preservation dosing pump 123 to the flow line 79 and can include a preservation chemical control valve 122. The preservation solution can be any suitable solution, such as 1% w/w sodium bi-sulfite (NaHSO₃) and/or sodium metabisulfite (Na₂S₂O₅). Additionally, a strong reducing agent can be used to prevent biogrowth in the system.

To operate the PRESERVATION mode 1100, the DRAIN-FLUSH mode 800 is first performed. Once the DRAIN-FLUSH mode 800 is complete, the membrane filtration module 40 can be completely isolated by closing all valves (the circulation valve 32, the return line control valve 84, the drain valve 38, the permeate control valve 75, the backwash control valve 78, the cleaning chemical solution control valves 82′ and 82″, and the preservation chemical control valve 122) as seen in step 1102.

Next, the backwash control valve 78 is opened; the backwash pump 77 is energized; and the tank control valve 83 is opened in step 1104. As a result, permeate is permitted to flow from the storage tank 90 through the backwash pump 77 through the backwash control valve 78, and into the membrane filtration module 40 in the reverse direction of normal flow. As previously mentioned, the backwash pump 78 can include more than one pump, for example three pumps can be used. In view of this, the number of backwash pumps 78 may be one or more than one for the PRESERVATION mode. Simultaneously, the preservation chemical dosing pump 123 is energized and the preservation chemical solution control valve 122 is opened. The chemicals from the preservation chemical source 120 are dosed directly into the backwash flow for a set period of time so as to fill the membrane filtration module 40. After the set period of time, the preservation chemical dosing pump 123 is de-energized and the preservation chemical solution control valve 122 is closed in step 1106. The permeate is allowed to continue for a brief period after the chemical dosing is complete in step 1106 (known as the Preservation Post Dosing Backwash Flow step) to flush the preservation chemical solution out of the backwash piping, i.e., flow lines 71, 74, and 79, and into the membrane filtration module 40. After this period of time the backwash pump 77 is turned off and the backwash control valve 78 is closed in step 1108.

The membrane filtration module 40 is permitted to soak for a period of time in step 1108 (known as the Preservation Chemical Soak step). The soaking time can be varied; however after about 30-90 days, the system should be re-preserved when in long-term storage, i.e., the membrane filtration module 40 should be drained by opening the drain valve 38 at step 1110 and fill up with fresh preservation chemicals by returning back to step 1102. An example of exemplary operating parameters of the PRESERVATION mode of operation are provided in Table 6 below. As with the operating parameters provided in the other modes, these parameters are examples only and other the parameters can be use based on the desired operational efficiency or desired output of the system.

TABLE 6
Operating Parameters for the PRESERVATION mode

| Operating Parameter | Operating Range | Comments |
|---|---|---|
| Preservation Chemical Dosing | 191 | Only one backwash pump need be used. |
| Bulk Flow (gpm) | | |
| Preservation Chemical Dosing | 88 | Only one backwash pump need be used. |
| Bulk Flux (gfd) | | |
| Preservation Chemical Dosing | 90–300 | Based on system configuration. |
| Duration (s) | | |
| Preservation | 1% w/w NaHSO₃ | A strong reducing agent can be |
| Chemical/Concentration | and/or Na₂S₂O₅ | used to prevent biogrowth in the system. |
| Preservation Post Dosing | 191 | Only one backwash pump need be used. |
| Backwash Flow (gpm) | | |
| Preservation Post Dosing | 1–15 | Changeable based on system |
| Backwash Duration (s) | | configuration |
| Allowable soak period (days) | 30–90 | The system should be re- |
| | | preserved every 30–90 days |
| | | when in long-term storage. |

In another embodiment, the preservation chemical source 120, the flow line 21, the preservation chemical dosing pump 123, and the flow line 124 can be removed and the preservation chemical solution can be placed into either the first chemical source 80′ with its introduction into the system being facilitated by the dosing pump 86′ and control valve 82′ or the second chemical source 80″ with its introduction into the system being facilitated by the corresponding dosing pump 86″ and control valve 82″.

Once it is determined by the operator to place the membrane filtration module 40 back into service after being in the PRESERVATION mode 1100, the PRESERVATION DRAIN mode 1200 is initiated as described below.

The PRESERVATION DRAIN Mode 1200

At the conclusion of the soaking time, a draining step 1112 can be initiated (known as the CEC Draining step) in which all valves are closed (the control valves 34, 75, 78, 82′, 82″, and 84) except the drain valve 38 and the optional venting valve 85 and all pumps are still stopped. Thus, the membrane filtration module 40 is permitted to gravity drain such that any remaining chemical solutions from the PRESERVATION mode can drain from the membrane filtration module 40, out the diffuser 41, into the line 37, and out the drain 39. This PRESERVATION Draining step can be performed for about 10-60 seconds before the drain valve (and the venting valve 85 if applicable) are closed at step 1114. The PRESERVATION DRAIN mode 120 proceeds to the OFF mode 300 followed by the FILTRATION mode 400.

In one embodiment, an optional backwashing can be performed after step 1114 as detailed in the BACKWASH mode 600 above.

The ESTOP Mode 1300

The ESTOP mode is the emergency stop mode, which is used to immediately stop all equipment in the event of an emergency. The mode can be activated by pressing an emergency switch, such as a “mushroom-type switch” located on the front of the controller 100. The ESTOP mode immediately de-energizes all equipment and closes all valves regardless of the operating mode or any other conditions. Once the ESTOP mode is activated the DRAIN-FLUSH mode should be performed before returning the system to service, i.e. to FILTRATION mode.

In addition to the above describe embodiments, the system 10 can also include various other features, such as various alarms used to check the status of the various components of the system. For example, a storage tank low-level alarm can alert the operator that the permeate in the storage tank 90 is too low or cannot provide sufficient volume for one complete backwash cycle for the membrane filtration module. A circulation pump failure alarm can be generated by dry contacts from the pump or a loss of the circulation flow meter signal (if the system 10 is so equipped). The controller could automatically call a STOP and DRAIN-FLUSH mode for the membrane filtration module 40 served by the offending pump. A blower failure alarm can be generated by a loss of air flow pressure to the membrane filtration module 40. A backwash pump failure alarm can be generated by dry contacts from the permeate pump or a loss of permeate flow and/or pressure from the membrane filtration module 40. In such a case, the controller can initiate the STOP and DRAIN-FLUSH modes for the affected membrane filtration module. A CEC chemical level alarm can be generated by a chemical level tank switch in the first and second cleaning chemical sources if there is not enough chemical solution for the chemical cleaning procedure, which will prevent the CEC modes from activating. Also, valve failure alarms can be used to detect a failure of various valves.

During the operation of the system 10, various parameters can be monitored and/or calculated and stored by the controller 100 in either continuously or at predetermined intervals. The monitored parameters are determined by various signals from various detectors. The monitored parameters can include the feed flow, the feed volume, the backwash flow, the backwash volume, the consumption of the first cleaning chemical solution, the consumption of the second cleaning chemical solution, the permeate turbidity, the feed pressure, and the permeate pressure. The calculated variables can include the TMP pressure during the filtration, the TMP pressure during the backwash, the flux during the filtration, the flux during the backwash, the permeability, the average daily permeability, the maximum daily permeability, the minimum daily permeability, the daily permeability slope, the weekly permeability slope, the daily slope, the daily minimum permeability slope, the total filtration time, the daily gross production, the number of backwashes, the daily backwash volume, the average filtration volume, the average filtration time, the number of CEC1 modes performed, the number of CEC2 modes performed, and the daily net production. Additionally, the controller can monitor and record the occurrence of the alarms (the type of alarm, the date, and time) and any changes in the settings (such as type of change, date, time, and operator number).

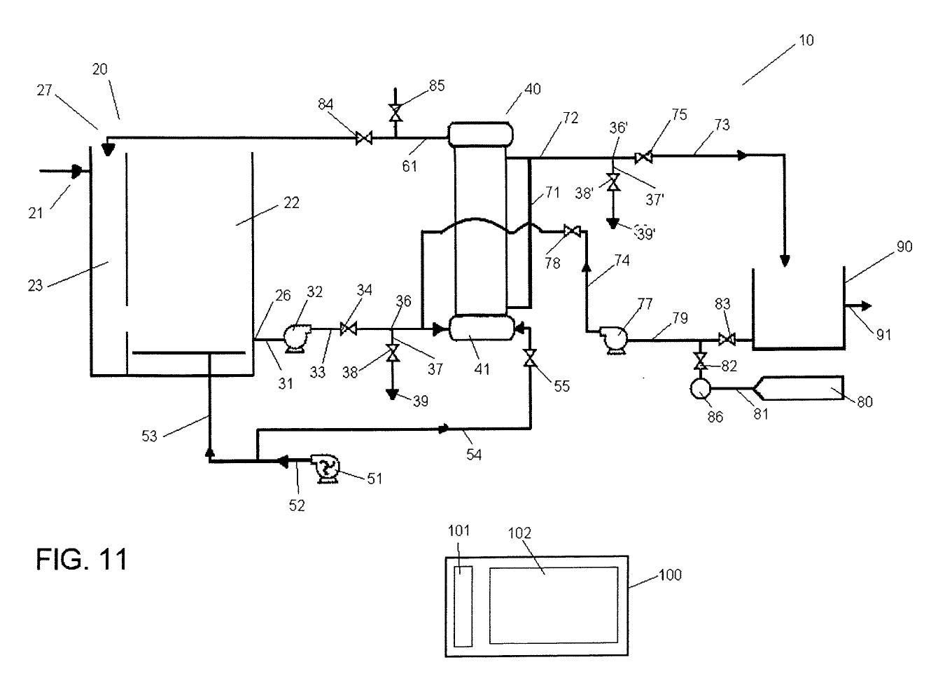

Given the disclosure of the present invention, one versed in the art would appreciate that there may be other embodiments and modifications within the scope and spirit of the invention. For example, FIG. 11 shows another embodiment of the present invention is which the pump 77 flow line 74 is connected to the input line 33 that leads to the diffuser 41 instead of the flow lines 71 and 72. In such an embodiment, the flows during the BACKWASH mode 600, the DRAIN-FLUSH mode 800, the CEC1 mode 900, the CEC2 mode 1000, and the PRESERVATION mode 1100 are treated differently in that the flow of the permeate flow during the BACKWASH and DRAIN-FLUSH modes, the permeate and cleaning chemical solutions for the CEC1 and CEC2 modes, or the permeate and the preservation chemical solution for the PRESERVATION mode would run in the direction of the feed liquid in the FILTRATION mode. In other words, the permeate would flow into the diffuser 41 and through the rest of the membrane filtration module 40, instead in the opposite direction of the FILTRATION mode, i.e., in the exit lines 71 and 72. The flow can then exit out the membrane filtration module through lines 71 and 72. The flow can then go to the T-branch 36′ right before the permeate control valve 75. During the BACKWASH mode 600, the DRAIN-FLUSH mode 800, the CEC1 mode 900, the CEC2 mode 1000, and the PRESERVATION mode 1100, the permeate control valve 75 would be closed while the drain valve 38′ is connected to the T-branch 36′ such that the backwash fluid, flushing fluid, the cleaning chemical solutions, and/or the preservation chemical solution would empty into the drain 39′ instead of the drain 39 or the storage tank 90. Of course, the drain valve 38 would be opened during the draining step of the DRAIN-FLUSH mode and the PRESERVATION DRAIN mode but the drain valve 38 would be closed during the other times during the BACKWASH mode 600, the DRAIN-FLUSH mode 800, the CEC1 mode 900, the CEC2 mode 1000, and the PRESERVATION mode 1100.

In yet another embodiment of the present invention, a plurality of filtration membrane modules 40 can be used as seen in FIG. 12 (the one or more air blowers and their connecting air lines have been removed for clarity). In this embodiment, a plurality of permeate control valves 75, a plurality of drain valves 38, a plurality of circulation valves 34, and a plurality of backwash control valves 78 can be used to isolate a particular filtration membrane module 40 for a particular process, such as the BACKWASH mode or the DRAIN-FLUSH mode when such modes are desired, while the other membrane filtration modules 40 can remain operation, i.e., in the FILTRATION mode.

Other embodiments and modifications are also within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A method of operating a membrane bioreactor wastewater treatment system, which system comprises a bioreactor and one or more membrane filtration modules, each module having a proximal end and a distal end and housing a plurality of membrane filters, in which influent is introduced into the bioreactor and from which bioreactor a feed liquid is obtained which is introduced, in turn, to the proximal end of the one or more membrane filtration modules, a substantial portion of which feed liquid is recovered from the distal end thereof and returned to the bioreactor, but at least a portion of which feed liquid is allowed to pass from one side of said plurality of membrane filters and out an opposite side thereof to provide a permeate, said method comprising:
interrupting the introduction of said feed liquid to said proximal end of the one or more membrane filtration modules;
allowing at least a portion of said feed liquid present in the one or more membrane filtration modules to drain therefrom, along with at least a portion of any residue that might have accumulated on the said one side of said plurality of membrane filters; and
resuming the introduction of said feed liquid to said proximal end of the one or more membrane filtration modules.

2. The method of claim 1 in which the introduction of said feed liquid is interrupted by closing an input valve.

3. The method of claim 1 in which the at least a portion of said feed liquid is allowed to drain by the action of gravity.

4. The method of claim 2 in which the at least a portion of said feed liquid is allowed to drain by opening a drain valve.

5. The method of claim 1 which further comprises, prior to the resumption of the introduction of said feed liquid, flushing said plurality of membrane filters by causing at least a portion of said permeate to flow from said opposite side of said plurality of membrane filters and out the one side thereof or to flow from the one side of said plurality of membrane filters and out the opposite side thereof.

6. The method of claim 5 which further comprises introducing a first chemical solution to the one or more membrane filtration modules.

7. The method of claim 6 which further comprises introducing a second chemical solution to the one or more membrane filtration modules.

8. The method of claim 6 in which the first chemical solution comprises one or more hypochlorite, acid, caustic, surfactant, or any combination thereof.

9. The method of claim 7 in which the second chemical solution comprises one or more hypochlorite, acid, caustic, surfactant, or any combination thereof.

10. The method of claim 1 in which the introduction of said feed liquid is interrupted at least once for every 6 hours of continuous operation of the said membrane bioreactor wastewater treatment system.

11. A method of maintaining a membrane filtration module having a proximal end and a distal end, said module housing one or more tubular membrane filters through which a substantial portion of a feed liquid is allowed to flow into the proximal end and out the distal end of the membrane filtration module and in which at least a portion of the feed liquid is allowed to pass from one side of the one or more membrane filters and out an opposite side thereof to provide a permeate, the method comprising:
interrupting the flow of feed liquid;
allowing at least a portion of said feed liquid present in the membrane filtration module to drain therefrom, along with at least a portion of any residue that might have accumulated on one side of the one or more tubular membrane filters;
flushing the one or more tubular membrane filters by allowing an effective amount of permeate to flow from said opposite side of the one or more tubular membrane filters and out the one side thereof or to flow from said one side of the one or more tubular membrane filters and out said other opposite side thereof; and
resuming the flow of feed liquid.

12. The method of claim 11 in which an effective amount of permeate ranges from about 0.05× to about 10× the total volume of the membrane filtration module.

13. The method of claim 11 in which the flushing step is carried out during or after the at least a portion of said feed liquid is allowed to drain.

14. The method of claim 13 in which the at least a portion of said feed liquid is allowed to drain by opening a drain valve positioned below the one or more tubular membrane filters and opening a vent positioned above same.

15. A membrane wastewater filtration system comprising:
one or more membrane filtration modules having a proximal end and a distal end, each module housing one or more tubular membrane filters;
at least one inlet for introducing feed liquid;
at least one drain positioned below the one or more tubular membrane filters;
at least a first outlet for recycling a substantial portion of feed liquid introduced;
at least a second outlet for recovering permeate; and
at least one controller configured to (i) interrupt the introduction of feed liquid, (ii) allow at least a portion of feed liquid present in the one or more membrane filtration modules to drain therefrom, and (iii) allow at least a portion of recovered permeate to backflush the one or more tubular membrane filters.

16. The wastewater treatment system of claim 15 which further comprises a first pump for feeding the feed liquid to the at least one inlet and a circulation valve in fluid communication with the first pump, and
the controller is configured to close the circulation valve to interrupt the introduction of the feed flow.

17. The wastewater treatment system of claim 15 which further comprises a second pump in fluid communication with the second outlet and a draining valve in fluid communication with the at least one drain.

18. The wastewater treatment system of claim 17, in which the controller is configured to turn on the second pump while the draining valve is open.

19. The wastewater treatment system of claim 17, in which the controller is configured to close the draining valve before turning on the second pump.

20. The membrane wastewater filtration system of claim 17 which further comprises an air blower for introducing air in the vicinity of the proximal end of the one or more membrane filtration modules, and
the controller is configured to control the air blower to run while the draining valve is open, the second pump is in operation, or any combination thereof.

21. The wastewater treatment system of claim 17 which further comprises a chemical solution source and chemical flow valve in fluid communication with the second pump, and
the controller is configured to open the chemical flow valve and to operate the second pump.

22. The membrane wastewater filtration system of claim 15, which further comprises an air blower for introducing air in the vicinity of the proximal end of the one or more membrane filtration modules.

23. The membrane wastewater filtration system of claim 22 in which the air blower is configured to introduce air continuously.

24. The membrane wastewater filtration system of claim 22 in which the air blower is configured to introduce air intermittently.

25. The membrane wastewater filtration system of claim 22 in which the air blower is connected to the proximal end of the one or more membrane filtration modules through a delivery device, and in which the filtration system further comprises a cleaning device for flushing the delivery device with at least one of a liquid and an air stream.

26. The membrane wastewater filtration system of claim 22 in which the at least one controller is configured to automatically adjust an amount of air being blown by the air blower as a function of a membrane operating parameter.
